(19) United States
(12) Patent Application Publication
(10) Pub. No.: US 2020/0001420 A1
(43) Pub. Date: Jan. 2, 2020

(54) METHOD AND APPARATUS FOR DETECTING OCCURRENCE OF AN ACCIDENT IN A CNC ENVIRONMENT

(71) Applicant: Siddhant Sarup, Ludhiana, Punjab (IN)

(72) Inventors: Siddhant Sarup, Ludhiana, Punjab (IN); Gaurav Sarup, Ludhiana, Punjab (IN); Prashant Sarup, Ludhiana, Punjab (IN)

(21) Appl. No.: 16/486,515

(22) PCT Filed: Feb. 16, 2018
(86) PCT No.: PCT/IN2018/050077

§ 371 Date: Aug. 16, 2019

(30) Foreign Application Priority Data
Feb. 16, 2017 (IN) 201711005604

(51) Int. Cl. B23Q 17/22; G05B 19/4061; G05B 19/4065; G08B 21/02; B23Q 17/09; B23B 3/30

(52) U.S. Cl. CPC B23Q 17/2208; G05B 19/4061; G05B 19/4065; G05B 2219/49143; B23Q 17/0957; B23B 3/30; G08B 21/02

(57) ABSTRACT

Embodiments of the present invention provide an automatic monitoring method and apparatus that automatically detects occurrence of an accident or a situation that may lead to an accident in a CNC machine and environment; and signals to take an appropriate action for rectifying the accidental situation. The method and apparatus may include a plurality of sensors that are mounted on various parts of the CNC machine, wherever required. The method, in execution, detects collisions and other failures/injuries in the CNC machine that lead to severe accidents and damage to the operation.

### FIELD OF THE INVENTION

The present invention relates to Computerized Numerical Control (CNC) machines and in particularly, relates to method and apparatus for detecting an accident occurring in the CNC machine and taking appropriate corrective measures, if required.

### BACKGROUND OF THE INVENTION

For large-scale devices such as a CNC machine or a dedicated device, device operating conditions need to be tested during the operation for timely maintenance and safe running of the device. Among the current technologies adopted for keeping a check on the quality and conditions of the devices; a monitoring technology for monitoring the malfunction and running condition of electrical parts has been more popular. In addition, self-inspection of the electronic parts is used to eliminate some hardware and software failures. However, monitoring of the running condition and parameters of the mechanical parts in the device has several problems in the field of fault detection and diagnosis.

Today, no reliable and autonomous system (free from human intervention) exists for detecting accidents occurring in the machine tools. This may result in huge losses, since any negligence/oversight/or a genuine mistake from the Operator can cause a crash in the machine. This may further cause breakages in tool and/or job and ‘internal injuries’ to the machine. Further, in the absence of proper and effective system for fault detection of part or parts of the machine, the operator continues operating the machine under fault, which causes further damages to the machine. No mechanism is provided to detect the internal injuries caused in the machines and to detect abnormal vibrations and sounds during slide movement and spindle rotation. Therefore, since the operator is not able to know the internal injuries caused in the machine, this may lead to increase in the number of accidents and further deteriorate the machine. Resultantly, the ‘Internal Injuries’ of the machine go unattended leading to rapid deterioration of machine in next few days/weeks till it finally breaks down and requires major overhaul. This additionally involves cost of new parts and unusually prolonged shutdown.

Accordingly, a need arises to develop a system which overcomes the fallacies of the current/prevalent systems and can aid in effective detection of faults and accidents during the operation of the machines.

### SUMMARY OF THE INVENTION

An embodiment of the present invention provides an automatic monitoring method for a CNC machine comprising the steps of:
detecting, by a collision detecting unit, one or more of following events, indicative of an accident occurring in the CNC machine:
   collision of a horizontal Z-axis and/or an X-axis, perpendicular to the Z-axis, of a slide of the CNC machine, with a headstock body and/or its sub-assemblies at a colliding force higher than a permitted colliding force; or
   collision of the X and/or Z axes with a tailstock, at a colliding force higher than a permitted colliding force;
   collision of X and/or Z axes, or one or more components of the CNC machine mounted on the axes, with a spindle assembly, at a colliding force higher than a permitted colliding force; and
   collision of X and/or Z axes, or the parts mounted on the axes, with one or more stationary components of the CNC machine at a colliding force higher than a permitted colliding force;
where the permitted colliding force is already pre-defined in the collision detecting unit;
sending a trigger signal, indicative of information details of the events, to a control unit;
detecting one or more axis overload alarms occurring within a predetermined time of receiving the trigger signal; and
triggering one or more corrective actions to be taken, on detecting that the one or more axis overload alarms have occurred within the predetermined time of receiving the trigger signal.

Another embodiment of the present invention provides an automatic monitoring system for a CNC machine comprises:
a collision detecting unit configured to detect one or more of following events, indicating of an accident occurring in the CNC machine:
   collision of a horizontal Z-axis and/or an X-axis, perpendicular to the Z-axis, of a slide of the CNC machine, with a headstock body and/or its sub-assemblies at a colliding force higher than a permitted colliding force; or
   collision of the X and/or Z axes with a tailstock, at a colliding force higher than a permitted colliding force;
   collision of X and/or Z axes, or one or more components of the CNC machine mounted on the axes, with a spindle assembly, at a colliding force higher than a permitted colliding force; and
   collision of X and/or Z axes, or the parts mounted on the axes, with one or more stationary components of the CNC machine at a colliding force higher than a permitted colliding force;
where the permitted colliding force is already pre-defined in the collision detecting unit;
a control unit to receive a trigger signal, indicative of information details of the events;
a detecting unit configured to detect if one or more axis overload alarms have occurred within a predetermined time of receiving the trigger signal; and
a processing unit for triggering one or more corrective actions to be taken, on detecting that the one or more axis overload alarms have occurred within the predetermined time of receiving the trigger signal.

It is an object of the present invention to determine occurrence of an accident or an internal injury in the CNC machine that may or may not be visible or noticeable to the operator during the operation of the machine or after the machine has come to a halt.

It is another object of the present invention to take appropriate action if any accident or an internal injury is found to have taken place.

It is another object of the invention to attend to the Internal Injuries of the machine at the right time before they go unattended, which could have lead to rapid deterioration of the machine and finally causing the break down and hence, requirement of a major overhaul.

To further clarify advantages and features of the present invention, a more elaborate description of the invention will be rendered by reference to specific embodiments thereof, which is illustrated in the appended drawings. It is appreciated that these drawings depict only typical embodiments of the invention and are therefore not to be considered limiting of its scope.

### BRIEF DESCRIPTION OF ACCOMPANYING DRAWINGS

These and other features, aspects, and advantages of the present invention will become better understood when the following detailed description is read with reference to the accompanying drawings in which like characters represent like parts throughout the drawings, wherein:

FIG. 1 shows a flow chart for a method for detecting accidents in a CNC machine, in accordance with an embodiment of the present invention;

FIG. 2 shows a block diagram for an apparatus for detecting accidents in a CNC machine by implementing the method illustrated in FIG. 1 in accordance with an embodiment of the present invention;

FIG. 3 shows an exemplary implementation of a CNC turning center when the turret is in safe position; in accordance with an embodiment of the present invention

FIG. 4 shows an exemplary implementation of a CNC turning center when the turret is in turning position; in accordance with an embodiment of the present invention and

FIG. 5 shows an exemplary implementation of a CNC turning center when the accident takes place; in accordance with an embodiment of the present invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The apparatus, system, methods, and examples provided herein are illustrative only and not intended to be limiting.

Embodiments of the present invention will be described below in detail with reference to the accompanying drawings.

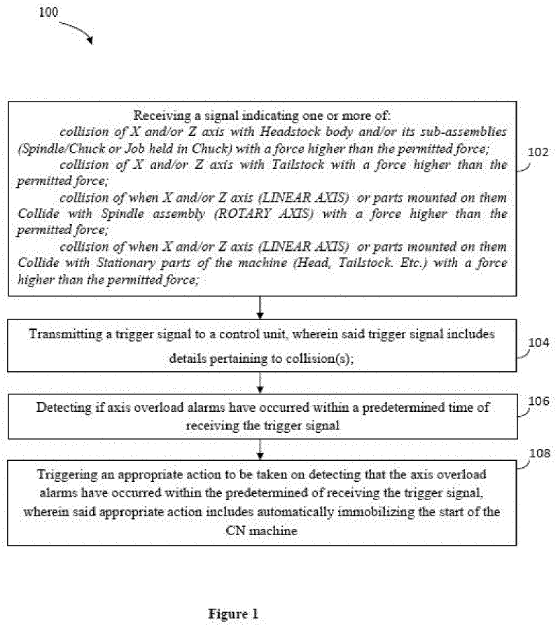

FIG. 1 illustrates a flowchart for a method 100 for detecting accidents in a CNC machine. For the purpose of a clear description of the method 100, a conventional CNC lathe machine is assumed. The CNC lathe machine has principal components for its working, which are a bed on which all the other components are mounted; a stationary headstock with its sub-assemblies such as including and not limited to spindle, chuck, face plate, job held in chuck and the like; a tailstock, a guide surface mounted on the bed and is movable in the direction of a horizontal Z-axis; a tool slide carrying a tool post on top of the guide surface which is movable in X-axis perpendicular to the X-axis, the guide surface and the tool slide may be together referred to as ‘tool mounting assembly’.

It is apparent to a person skilled in the art that a conventional CNC machine has more components than described above.

The present invention provides a method and a system that monitors the functioning and environment of the CNC machines to detect any occurrence of an accident in the machines that may or may not be visible to an operator; and further decide to take an appropriate action, if any accident or an internal injury is found to have taken place. In the monitoring system, the CNC machine may include a plurality of sensors that sense one or more actions which may indicate an accident happening in the machine.

In the FIG. 1, the method 100 comprises a step 102 of receiving a signal, from the sensors mounted on the CNC machines, indicating one or more of the following events that may have happened in the machine: collision of the horizontal Z-axis and/or the X-axis, perpendicular to the Z-axis of the tool slide, with the Headstock body and/or its sub-assemblies (Spindle/Chuck or Job held in Chuck) at a force higher than a permitted force; collision of the X and/or Z axes with the tailstock at a force higher than the permitted force; collision of X and/or Z axes or the parts mounted on these axes with the spindle assembly (ROTARY AXIS) with a force higher than the permitted force; and collision of X and/or Z axis or parts mounted on them with stationary parts of the CNC machine (Head, Tailstock. etc.) with a force higher than the permitted force, where the permitted (or colliding) force is already pre-defined in the sensors that detect these collisions.

Once the signal indicating the collision is received by a receiver, the method 100 includes step 104 of sending a trigger signal to a control unit by a transmitter, where the trigger signal includes data pertaining to collision(s). The data may include information relating to and not limited to the nature and cause of accident/collision, date and time of collision, part or parts affected due to collision, level of force which caused the collision and the like. Once the details pertaining to the collision(s) are received, the method 100 includes a step 106 of detecting if axis overload alarms have occurred within a predetermined time of receiving the trigger signal; and step 108 of triggering an appropriate action to be taken on detecting that the axis overload alarms have occurred within the predetermined time of receiving the trigger signal, where the appropriate action includes and not limits to automatically immobilizing the start of the CNC machine.

In an embodiment, the collision detection is done using one or more sensors mounted at various positions in the CNC machine, such as at Headstock and tailstock and other different places, if required. The sensors may be vibration detection sensors in which a threshold or a pre-defined permitted colliding force is set. If this is exceeded, the sensor releases a digital output, which is referred to as the trigger signal in this present invention (TRIGGER).

In an exemplary embodiment, the sensors are fitted/installed on the headstock to take the readings of the Axis & Spindle Motors in addition to the Vibration to conclude some fault or injury that may have taken place in the machinery. The vibrations in the spindle bearings are measured using highly sensitive one or more vibration sensors; and currents drawn by the servo motors and spindle motors are measured using current measuring devices in their electric drive modules. The current measuring devices are standard devices including ammeter, multi meter etc. that are well known to a person skilled in the art. Vibrations are measured through a very sensitive accelerometer fitted above the front bearings of the spindle. By way of example, a standard CNC turning center is disclosed in EP patent application EP19860302884 entitled ‘CNC Turning machine’. The details of the same are incorporated herein by reference. The present application is however applicable to other CNC turning centers too having servo axis motors and spindle(s).

In an embodiment, the overload alarms can occur because of the overload situations like electrical disturbances, excessive cut, brake activation during servo motor running (electrical error) and others.

In an embodiment, the overload alarms are automatically generated and allow the system to go to LOG BOOK of the CNC machine. An access is provided to the Log book and if Overload signal is generated, the transmitter sends a signal to the control unit.

In an embodiment, the appropriate action includes and is not limited to sending a notification in the form of a message, voice call, short call, email, USSD etc. once axis overload alarms have occurred within a predetermined time of receiving the trigger signal. The notification may provide the option to take an appropriate action remotely by sending a signal from the remote location.

In an embodiment, the appropriate action of immobilizing of the machine may be realized by Switching off the power to CNC CPU that goes through a special hidden fuse. For example, switching off the CPU by transmitting a current to the fuse to burn it. Other immobilizing actions include PLC LADDER Logic and other mechanisms, that are well known to a person skilled in the art, for immobilizing the machine, such that the machine does not re-start (until appropriate action/repair is done). In an embodiment, the machine re-starts only after the faults in the machined caused due to the collision and overload alarms in machine have been rectified.

In an exemplary embodiment, the method 100 includes detecting Clogging of any oil line. In case the clogging of any line is detected, an appropriate action may be taken. The clogging of the line causes dry running of axis which show as increase in load (current) during health checkup. This is automatically detected by the present invention and on detection, an appropriate action is taken.

In an embodiment, the method 100 includes triggering an appropriate action to be taken on detecting internal injuries and premature failure of machine. The internal injuries may include failure or malfunctioning of a key component of the machine, leakage or breakdown caused in any part of the machine etc.

In an embodiment, the method 100 includes sending the status (start, re-start, failure, break-down, maintenance) of the part or parts of CNC Machine or complete CNC machine thereof to the CNC machine manufacturer, CNC machine operator, CNC machine server, cloud server etc.

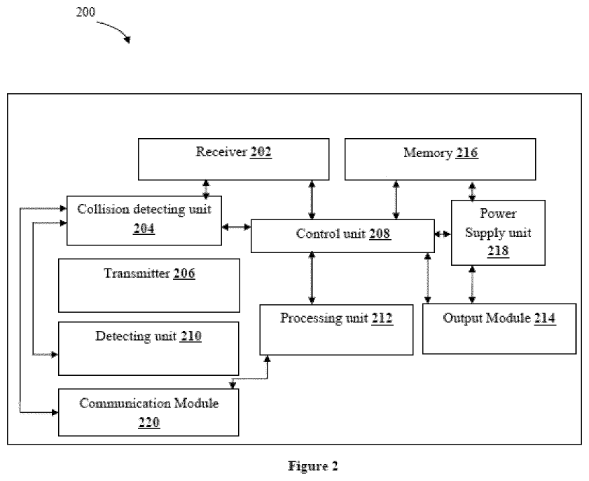

Referring to FIG. 2, an apparatus for detecting accidents in a CNC machine is provided. In an embodiment, the apparatus 200 for detecting accidents in a CNC machine is provided. The apparatus 200 comprises: a receiver 202 configured for receiving a signal indicating one or more of the following actions that may have happened in the machine: collision, detected by a collision detecting unit 204, of the horizontal Z-axis and/or the X-axis, perpendicular to the Z-axis of the tool slide, with the Headstock body and/or its sub-assemblies (Spindle/Chuck or Job held in Chuck) with a force higher than a permitted colliding force; collision, detected by the collision detecting unit 204, of the X and/or Z axes with the tailstock with a force higher than the permitted colliding force; collision, detected by the collision detecting unit 204, of X and/or Z axes or parts mounted on them with the spindle assembly (ROTARY AXIS) with a force higher than the permitted force; collision, detected by the collision detecting unit 204, of X and/or Z axes (LINEAR AXIS) or parts mounted on them with the stationary parts of the machine (Head, Tailstock. etc.) with a force higher than the permitted force.

A transmitter 206 is configured for sending a trigger signal to a control unit 208, where the trigger signal includes data pertaining to collision(s). A detecting unit 210 including one or more processors and microprocessors configured for detecting if axis overload alarms have occurred within a predetermined time of receiving the trigger signal; and a processing unit 212 for triggering an appropriate action to be taken on detecting that the axis overload alarms have occurred within the predetermined time of receiving the trigger signal, where the appropriate actions may include and not limit to automatically immobilizing the start of the CNC machine.

The apparatus 200 further includes an output module 214 such as a display for displaying one or more of:
a. the measured current and vibrations before, during and after the collision;
b. details of collisions;
c. details of appropriate actions to be taken based on the signal received;
d. log details pertaining to the collisions, injury caused in the machine, stored in memory 216.

In an embodiment, the apparatus 200 further includes a power supply unit 218 for supplying power various components of the apparatus 200. A communication module 220 is further provided for communicating and notifying the details of the accidents and the reasons, time of occurrence thereof to one or more connected devices and officials. The one or more units/modules described above may be standalone components or more than one operation may be performed by a single unit. For example, the operations of receiver and transmitter may be performed using a single transceiver; the control unit and processing unit may form a single standalone entity and so on.

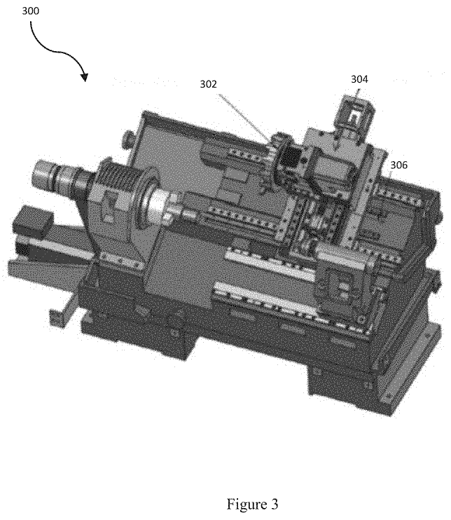

Referring to FIGS. 3-5, exemplary implementations of a CNC machine depicting occurrence of an accident are illustrated. The CNC machine herein referred includes a CNC lathe. A CNC lathe/machine can be any machine available in the market. For instance, in the implementations, a lathe or chucker, having a tool carrying turret mounted upon an X-axis slide which is movable perpendicular to the spindle axis, is provided with a gage head incorporating a reflector adapted to be positioned for measurement by an indexing rotation of the turret to a particular index station. An interferometer is fixedly mounted upon a Z-axis slide (which carries the X-axis slide) movable parallel to the spindle axis.

The interferometer is aligned with the reflector in the gage head when the turret is in the measurement index station and is always aligned with a laser source and receiver mounted upon the machine tool frame or adjacent thereto. The chuck is encircled by a master reference collar of known diameter (internal as well as external) whereby a reference point may be established when the gage head engages the inner or outer periphery of the collar.

The FIGS. 3-5 of the present invention may also illustrate another implementation of a CNC machine, such as described in a patent numbered EP-0 259 637-B which has a headstock for mounting a work piece spindle which is displaceable in the direction of the Z-axis and a tool carrier slide which, for its part, is borne by a lower slide displaceable in the direction of the X-axis. The tool carrier slide designed as a sleeve-guided slide is displaceable in the lower slide in the direction of the Y-axis, which is at right angles to the plane defined by the X-axis and the Z-axis, and mounted for rotation about the Y-axis so that the tool carrier mounted on the tool carrier slide has a B-axis. A drivable tool spindle, e.g. for a milling tool, is mounted in this tool carrier such that the spindle axis extends transversely to the Y-axis. Above the cross-slide system formed by the lower slide and the sleeve-guided slide, this known lathe has a tool magazine with which a tool changer is associated in order to be able to change the tool held in the tool spindle after the tool carrier has been swiveled through 180° about the B-axis or Y-axis.

Another implementation is described in EP-0 185 011-B which discloses an automatic turret lathe, the turret head of which has at least one tool receiving means for a driven tool, in particular a milling tool. The purpose of this known lathe is to replace a true Y-axis of a tool carrier slide system by a swiveling of the tool turret about a B-axis, coordinated with a transverse feed, and/or a rotation of the turret head about its indexing axis. For this purpose, the tool turret is arranged on a cross slide system having a Z-axis and an X-axis, a turret body is mounted on the upper slide of this cross-slide system so as to be pivotable about the Y-axis and consequently has a B-axis, and the turret head is held on the turret body so as to be rotatable about an indexing axis (A-axis) extending transversely to the Y-axis. This known lathe therefore has the disadvantage mentioned at the outset i.e. only tools having a relatively small machining capacity can be accommodated in the turret head. In addition, a non-driven tool having a high machining capacity, such as, e.g., a boring bar, which is mounted on a turret head, can also not be completely satisfactory because the high forces occurring at such a tool prevent the manufacture of very precise work pieces—in this connection it must be borne in mind that such a turret head must be held on the turret body so that it is not only rotatable about its indexing axis but, normally, also displaceable in the direction of the indexing axis because the turret head must be lockable on the turret body against any unintentional rotation. This is generally accomplished with two crown gears which intermesh when the turret head is locked and are separated from one another when the turret head is rotated due to a displacement of the latter in the direction of its indexing axis.

However, the present invention may be implemented in other types of CNC lathe machines as well. The sensors for determining the collisions and oil leaks are suitably positioned on the headstock, tail stock or any other part depending upon the nature, type and size of the machine.

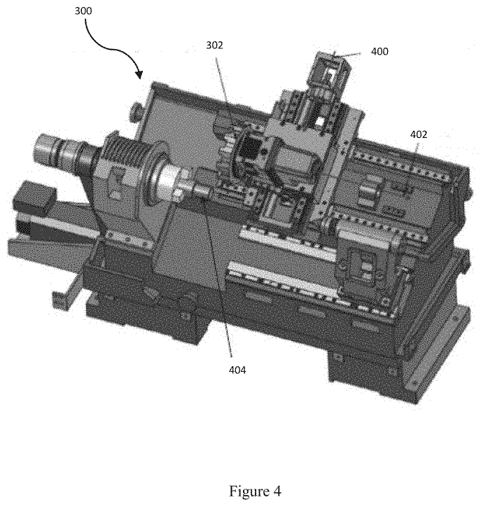

FIG. 3 shows an exemplary implementation of a CNC turning center/lathe 300, when the turret 302 is in safe position. As can be seen in FIG. 3, the 302 turret is in a safe position implying that no accident has taken place. The slide x-axis position 304 and z-axis position 306 is also illustrated in FIG. 3. FIG. 4 shows an exemplary implementation of a CNC turning center 300 when the turret 302 is in a turning position. As can be seen in FIG. 4, the position of the turret 302 changes when the turret 302 is in the turning position, from previous X-axis position 304 to now 400 and the previous Z-axis position to 306 to now 402, bringing the turret 302 close to the job 404.

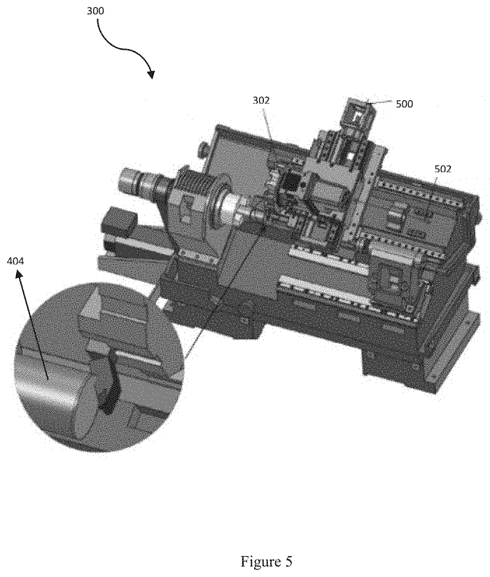

FIG. 5 shows an exemplary implementation of the CNC turning center 300 when the accident takes place i.e. the turret 302 collides with job. The position of the turret 302 further changes when the turret 302 is in the turning position, from previous the X-axis position 400 to now 500 and the previous Z-axis position to 402 to now 502, colliding the turret 302 with the job 404 now which results in an accident. This occurrence of the accident is detected by the present invention and an appropriate action such as notifying the concerned operators/administrators relating to the CNC machine; immobilizing the CNC machine takes place. Depending upon the requirements, the CNC machine may, thereafter, be re-started only after the repair or after the supervision of the concerned authority.

The present invention may be implemented using a typical hardware configuration of a computer system, which is representative of a hardware environment for practicing the present invention. The computer system can include a set of instructions that can be executed to cause the computer system to perform any one or more of the methods disclosed. The computer system may operate as a standalone device or may be connected, e.g., using a network, to other computer systems or peripheral devices. In a networked deployment, the computer system may operate in the capacity of a server or as a client user computer in a server-client user network environment, or as a peer computer system in a peer-to-peer (or distributed) network environment.

The benefits of the present invention include Immobilized machine+automatic instantaneous message to several responsible parties which ensures that the operator cannot remove evidence of the accident. This results in very careful operation of machines in future. Expert maintenance people can check all the sub-assemblies (over several hours) which result in detection of ‘internal injuries’ and execution of corrective action which results in the machine running soon.

Therefore there is no major damage to machine & unusual prolonged shutdowns in future. Sudden, unexpected breakdowns will be avoided. Consequently, stoppage of downstream machines/processes will not occur and there will be no stoppage/delay of shipments to customers.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed.

Also, those acts that are not dependent on other acts may be performed in parallel with the other acts. The scope of embodiments is by no means limited by these specific examples.

Numerous variations, whether explicitly given in the specification or not, such as differences in structure, dimension, and use of material, are possible. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

I claim:

1. An automatic monitoring method for a CNC machine comprising the steps of:
detecting, by a collision detecting unit, one or more of following events, indicative of an accident occurring in the CNC machine:
collision of a horizontal Z-axis and/or an X-axis, perpendicular to the Z-axis, of a slide of the CNC machine, with a headstock body and/or its sub-assemblies at a colliding force higher than a permitted colliding force; or
collision of the X and/or Z axes with a tailstock, at a colliding force higher than a permitted colliding force;
collision of X and/or Z axes, or one or more components of the CNC machine mounted on the axes, with a spindle assembly, at a colliding force higher than a permitted colliding force; and
collision of X and/or Z axes, or the parts mounted on the axes, with one or more stationary components of the CNC machine at a colliding force higher than a permitted colliding force;
where the permitted colliding force is already pre-defined in the collision detecting unit;
sending a trigger signal, indicative of information details of the events, to a control unit;
detecting one or more axis overload alarms occurring within a predetermined time of receiving the trigger signal; and
triggering one or more corrective actions to be taken, on detecting that the one or more axis overload alarms have occurred within the predetermined time of receiving the trigger signal.

2. The method as claimed in claim 1, wherein the collision detecting unit may comprise one or more sensors, such as vibration sensors, current measuring devices, leakage detection sensors, and the like, installed or mounted on one or more components of the CNC machine, such as headstock, tailstock, spindle, chuck, tool post or others depending on the requirements.

3. The method as claimed in claim 2, wherein the vibration sensors include and not limit to highly sensitive accelerometer and the like, the current measuring devices include and not limit to ammeter, multi meter and the like.

4. The method as claimed in claim 1, wherein the collision detecting unit measures the amount of the colliding force and compares with the permitted colliding force for the one or more events occurring; and releases a digital output indicative of the events to a receiver, which in turn sends the trigger signal to the control unit via a transmitter.

5. The method as claimed in claim 1, wherein the headstock sub assemblies include and not is not limited to a Spindle, chuck, job held in Chuck, and the like.

6. The method as claimed in claim 1, wherein the stationary components of the CNC machine are headstock, tailstock, etc.

7. The method as claimed in claim 1, wherein the trigger signal indicating the information details of the events include the information relating to and not limited to nature and cause of the accident/collision, date and time of the collision, component(s) affected due to the collision, level of the colliding force which caused the collision and the like.

8. The method as claimed in claim 1, wherein the cause of axis overload alarm include and is not limited to overload situations like electrical disturbances, excessive cut, brake activation during a servo motor running (electrical error) and others.

9. The method as claimed in claim 1, wherein the method further comprises accessing a Log Book of the CNC machine, when the axis overload alarms are generated.

10. The method as claimed in claim 1, wherein the corrective actions include and are not limited to automatically immobilizing the CNC machine; sending a notification in the form of a message, voice call, short call, email, USSD etc.

11. The method as claimed in claim 10, wherein automatically immobilizing the CNC machine is done by executing mechanisms, such as, switching off power to CNC-CPU that goes through a special hidden fuse, by sending a current to the fuse to burn it, or a PLC LADDER Logic or other mechanisms.

12. The method as claimed in claim 10, wherein the notification is sent to any one or more of a CNC machine manufacturer, a CNC machine operator, a CNC machine server, cloud server etc and further may also include an option to take an appropriate corrective action remotely by sending a signal from a remote location.

13. The method as claimed in claim 1, wherein the events indicative of an accident occurring in the CNC machine may also include detecting clogging/leaking of one or more oil lines which is detected by increase in load (current) in the CNC machine; detecting internal injuries and premature failure of the CNC machine, where the internal injuries may include failure or malfunctioning of a key component of the machine, leakage or breakdown caused in any part of the machine etc.

14. An automatic monitoring system for a CNC machine comprises:
a collision detecting unit configured to detect one or more of following events, indicating of an accident occurring in the CNC machine:
collision of a horizontal Z-axis and/or an X-axis, perpendicular to the Z-axis, of a slide of the CNC machine, with a headstock body and/or its sub-assemblies at a colliding force higher than a permitted colliding force; or
collision of the X and/or Z axes with a tailstock, at a colliding force higher than a permitted colliding force;
collision of X and/or Z axes, or one or more components of the CNC machine mounted on the axes, with a spindle assembly, at a colliding force higher than a permitted colliding force; and
collision of X and/or Z axes, or the parts mounted on the axes, with one or more stationary components of the CNC machine at a colliding force higher than a permitted colliding force;
where the permitted colliding force is already pre-defined in the collision detecting unit;
a control unit to receive a trigger signal, indicative of information details of the events;
a detecting unit configured to detect if one or more axis overload alarms have occurred within a predetermined time of receiving the trigger signal; and
a processing unit for triggering one or more corrective actions to be taken, on detecting that the one or more axis overload alarms have occurred within the predetermined time of receiving the trigger signal.

15. The system as claimed in claim 14 further includes an output module, such as a display, for displaying one or more of:
a measured current and vibrations before, during and after the collision;
details of the collisions;
details of corrective actions to be taken based on the signal received; and
log details pertaining to the collisions, injury caused in the machine.

16. The system as claimed in claim 14 further includes a power supply unit for supplying power various components of the system; a communication module for communicating and notifying the details of the accidents and the reasons, time of occurrence thereof to one or more connected devices and officials.

17. The system as claimed in claim 14, wherein the collision detecting unit may comprise one or more sensors, such as vibration sensors, current measuring devices, leakage detection sensors, and the like, installed or mounted on one or more components of the CNC machine, such as headstock, tailstock, spindle, chuck, tool post or others depending on the requirements.

18. The system as claimed in claim 17, wherein the vibration sensors include and not limit to highly sensitive accelerometer and the like, the current measuring devices include and not limit to ammeter, multi meter and the like.

19. The system as claimed in claim 14, wherein the collision detecting unit measures the amount of the colliding force and compares with the permitted colliding force for the one or more events occurring; and releases a digital output indicative of the events to a receiver, which in turn sends the trigger signal to the control unit via a transmitter.

20. The system as claimed in claim 14, wherein the trigger signal indicating the information details of the events include the information relating to and not limited to nature and cause of the accident/collision, date and time of the collision, component(s) affected due to the collision, level of the colliding force which caused the collision and the like.

21. The system as claimed in claim 14, wherein the cause of axis overload alarm include and is not limited to overload situations like electrical disturbances, excessive cut, brake activation during a servo motor running (electrical error) and others.

22. The system as claimed in claim 14, wherein the corrective actions include and are not limited to automatically immobilizing the CNC machine; sending a notification in the form of a message, voice call, short call, email, USSD etc.

23. The system as claimed in claim 22, wherein automatically immobilizing the CNC machine is done by executing mechanisms, such as, switching off power to CNC-CPU that goes through a special hidden fuse, by sending a current to the fuse to burn it, or a PLC LADDER Logic or other mechanisms.

24. The system as claimed in claim 22, wherein the notification is sent to any one or more of a CNC machine manufacturer, a CNC machine operator, a CNC machine server, cloud server etc and further may also include an option to take an appropriate corrective action remotely by sending a signal from a remote location.

25. The system as claimed in claim 14, wherein the events indicative of an accident occurring in the CNC machine may also include detecting clogging/leaking of one or more oil lines which is detected by increase in load (current) in the CNC machine; detecting internal injuries and premature failure of the CNC machine, where the internal injuries may include failure or malfunctioning of a key component of the machine, leakage or breakdown caused in any part of the machine etc.
